(19) United States
(12) Patent Application Publication
(10) Pub. No.: US 2009/0126854 A1
(43) Pub. Date: May 21, 2009

(54) COMPOSITE COVER FOR TRANSPORT REFRIGERATION UNIT AND METHOD OF FABRICATING

(75) Inventor: Shafi N. Khan, Cicero, NY (US)

Correspondence Address: MARJAMA MULDOON BLASIAK & SULLIVAN LLP, 250 SOUTH CLINTON STREET, SUITE 300, SYRACUSE, NY, 13202, US

(73) Assignee: CARRIER CORPORATION, Farmington, CT (US)

(21) Appl. No.: 12/299,041

(22) PCT Filed: May 9, 2006
(86) PCT No.: PCT/US06/18290

§ 371 Date: Oct. 30, 2008

(51) Int. Cl. B32B 5/18; B23P 19/04

(52) U.S. Cl. 156/78; 29/700

(57) ABSTRACT

A method of fabricating a door for a cover of a transport refrigeration unit includes the steps of forming first and second sheets of plastic material, forming a core member of foam material, assembling the core member of foam material between the first and second sheets of plastic material, and bonding the respective peripheral edges of the first and second plastic sheets together. A transport refrigeration unit has a front cover that includes a pair of front doors of composite structure. Each door is formed of an inner sheet and an outer sheet of plastic material bonded together at their respective peripheral edges about a core of preformed foam material between said first and second sheets.

### FIELD OF THE INVENTION

This invention relates generally to transport refrigeration units and, more particularly, to composite outer protective covers for such units.

### BACKGROUND OF THE INVENTION

A typical transport refrigeration unit of the type designed for mounting on the front face of a tractor trailer unit comprises a one piece, self-contained fully refrigerant charged, pre-wired, refrigerant/heating unit powered by a diesel engine. In such a design the evaporator section fits into a rectangular opening in the upper portion of the trailer front wall. When installed, the evaporator section is located inside the trailer and the condensing section is outside and on the front of the trailer. The condensing section consists of an engine-compressor drive package, condenser fan, condenser coil, radiator coil, control panel, relay module, refrigerant controls, piping, wiring and associated components.

Structural frame members support all of the components and facilitate attaching of the unit to the trailer front face. Also supported by the structural framework is an outer protective cover which includes a grille portion providing the necessary air inlet and outlet openings for air cooling of the condenser coil, and outer doors which may be opened to provide access to the interior of the unit for maintenance and service.

In conventional practice, the outer doors are a composite structure formed of a twin sheet structure filled with polyurethane foam. A transport refrigeration unit provided with a protective outer cover having such composite structure outer doors is disclosed in commonly assigned U.S. Pat. No. 5,388,424, the entire disclosure of which is herein incorporated by reference. In conventional practice, such doors are fabricated using a twin sheet forming process wherein a pair of sheets are separately formed, such as by vacuum forming or thermoforming, to a desired profile from a thermoplastic material, typically acrylonitrile butadiene styrene (ABS). The preformed sheets are then placed in a contact along there respective peripheral edges and heated such that the contacting peripheral edges are fused together via twin sheet molding to form a shell having a hollow interior. Next, the hollow shell is then clamped between conforming mold halves and the hollow interior of the shell is filled with a polyurethane foam material via a conventional foam-in-place process wherein the two polyurethane precursor compounds are injected into the hollow interior to react within the interior. As the compounds react, expanding polyurethane foam fills the hollow interior of the shell. The foam-filled, plastic-skinned composite structure is then painted to provide an ascetically pleasing outer door structure.

The polyurethane foam filling the interior of the plastic-skinned shell generally continues to cure in place for a period of days or even weeks after the outer surface of the shell has been painted. During this period of prolonged curing, there is a potential for voids to form at the interface of the foam material with the inside surface of the plastic sheets. The presence of such voids on the inside surface of the plastic sheets results in an area of the outer skin that is not directly structurally backed by the foam material. Such area would be more susceptible to impact damage.

### SUMMARY OF THE INVENTION

It is an object of an aspect of the invention to provide an improved method for fabricating the doors of an outer protective cover for a transport refrigeration unit.

It is an object of an aspect of the invention to provide a transport refrigeration unit having an outer protective cover having outer doors of a composite structure formed of a plastic shell surrounding a foam core formed from a preformed sheet of foam material.

In an aspect of the invention, a transport refrigeration unit of the type adapted to be mounted on the front wall of a trailer for conditioning the environment interior of the trailer includes a front cover having a front door made of inner and outer sheets having respective peripheral edges which are bonded together to form a shell about a core of preformed foam material disposed between the first and second sheets. In an embodiment, the respective peripheral edges of the first and second sheets of plastic material are bonded together by a thermoforming process. In an embodiment the first and second sheets of plastic material are formed of an acrylonitrile butadiene styrene (ABS) plastic. The preformed core of foam material may be formed of a polyurethane foam, a sound dampening foam, a thermal insulating foam, or a reticulated polyurethane foam.

In an aspect of the invention, a method of fabricating a door for a cover of a transport refrigeration unit includes the steps of: forming a first sheet and a second sheet of a plastic material, forming a core member of a foam material, assembling the core member of foam material between the first and second sheets of plastic material with the respective peripheral edges of the first and second sheets of plastic material in contact; and bonding the peripheral edges of first and second sheets of plastic material together. The respective peripheral edges of first and second sheets of plastic material may be bonded together by fusing the respective peripheral edges of first and second sheets of plastic material via a thermoforming process. The method may include a further step of thermal bonding the preformed core member of foam material to the first and second sheets of plastic material during the thermoforming process.

In an embodiment, the method may also include the step of selectively varying at least one property of the foam material from which the core member is fabricated to selectively impart a desired characteristic to the core member. The step of selectively varying at least one property of the foam material from which the core member is fabricated to selectively impart a desired characteristic to the core member may include varying at least one of the density or the degree of reticulation of the foam material to selectively impart at least one of a desired thermal insulating value or a desired degree of sound dampening to the core member. The step of forming a core member of foam material may include forming the core member of a polyurethane foam material, of a thermal insulating foam material, of a sound dampening foam material, or of a reticulated foam material.

### BRIEF DESCRIPTION OF THE DRAWINGS

For a further understanding of these and other objects of the invention, reference will be made to the following detailed description of the exemplary embodiment depicted in the accompanying drawing, wherein:

FIG. 1 is a perspective view of a transport refrigeration unit having a cover having a composite structure doors in accordance with the invention;

FIG. 2 is a sectional view taken along line 2-2 of FIG. 1 of an exemplary embodiment of the composite structure door of the invention; and

FIG. 3 is a block diagram illustrating the steps of an exemplary embodiment of a method of fabricating a composite structure door for the outer protective cover of a transport refrigeration unit in accordance with the invention.

### DETAILED DESCRIPTION OF THE INVENTION

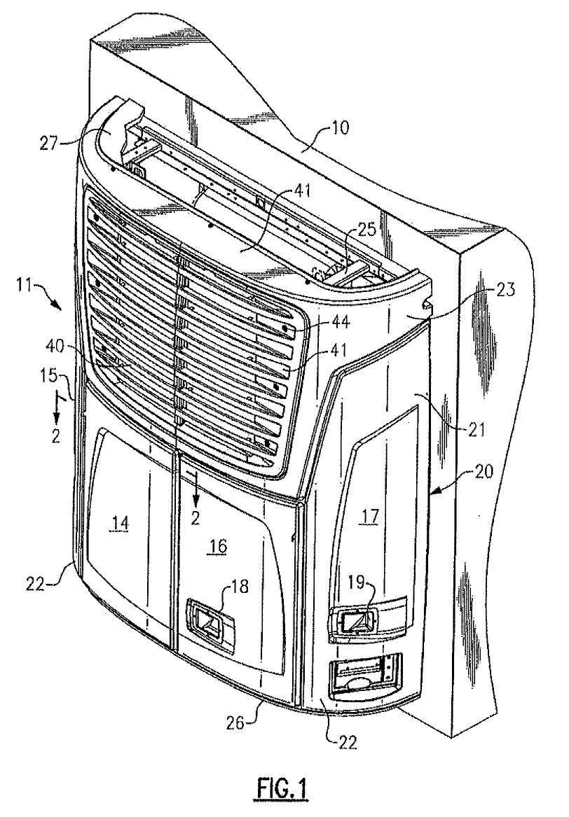

Referring now to FIG. 1, a fragmentary front part of a large transport trailer 10 is shown with a transport refrigeration unit 11 mounted on the front wall of the trailer. For purposes of the present description the terms “roadside” and “curbside” will be used in describing various components of the refrigeration unit and its cover. As viewed in FIG. 1, the right hand side of the unit will be referred to as the roadside and the left hand side of the unit as the curbside of the unit.

With this reference, the transport refrigeration unit 11 as illustrated in FIG. 1 has an outer cover 20 having a lower cover assembly 21 and an upper cover assembly 23. Attachment of the refrigeration unit 11 to the trailer 10 is carried out by connection of an outer peripheral planar structural steel framework designated generally by reference numeral 25. It should be appreciated that this framework is not normally visible when the unit is properly installed on a trailer unit, however for purposes of illustration, at least a portion of the structural framework is illustrated in FIG. 1. All of the component assemblies which define the outer cover of the refrigeration unit 11 are mounted to the various structural members of the framework 25.

The upper cover assembly 23 comprises a relatively rigid front grille member 40 and a relatively flexible support structure 42, also referred to herein as the surround assembly, disposed in surrounding relationship therewith. The grille member 40 is positioned in overlying relationship with a center opening in the surround assembly 42 and the condenser heat exchanger therebehind (not shown). The grille is provided with a plurality of openings 41 therethrough to facilitate air flow for efficient heat transfer to cool the condenser coil of the refrigeration unit.

The lower cover assembly 21 includes a curbside front door 14, a curbside outer door 15, a roadside front door 16, a roadside outer door 17, all shown in their closed positions, side panels 22 and bottom panel 26. The front doors 14 and 16 are vertically hinged at their respective outer edges so as to swing outwardly to open to provide a large access opening at the front of the unit, thereby providing access to the inner structural components of the unit as well as some of the components of the refrigeration system itself. The outer doors 15 and 17 are mounted within the respective side panels 22 and vertically hinged at their respective rear edges such that they pivot open from front to back to provide additional access openings to the interior of the refrigeration unit at the sides of the unit. Latches 18 and 19 are provided for latching and unlatching the front roadside door 16 and side roadside door 17, respectively.

A top panel 27 is attached to the upper cover assembly of the unit for purposes of closure and to improve the aesthetics of the unit. A bottom panel 26 is attached to the lower cover assembly for purposes of closure and to improve the aesthetics of the unit. It will be appreciated therefore that the door, panel, surround assembly and grille components described above are designed to cooperate to fully enclose the refrigeration unit 11 to provide protection from the environment and road hazards and to aerodynamically and aesthetically enhance the unit.

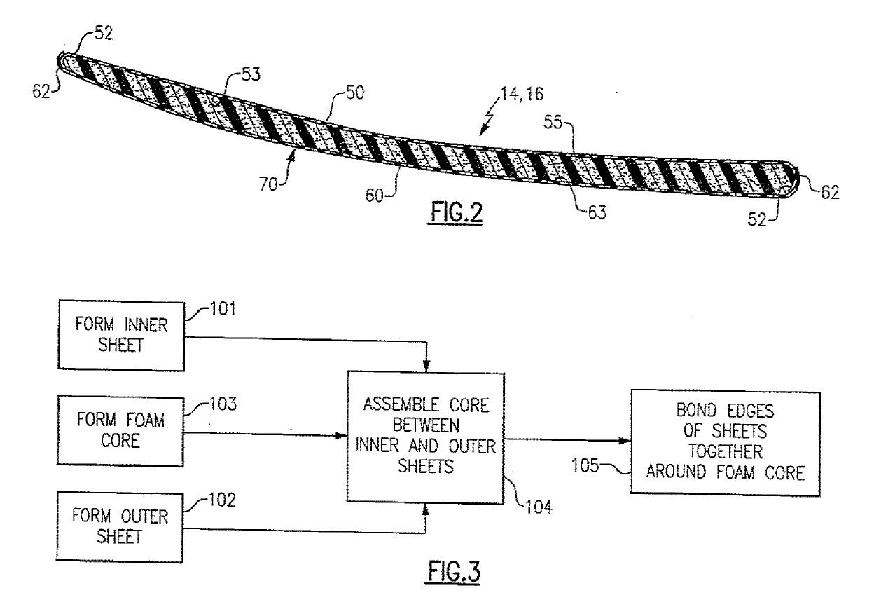

Referring now to FIG. 2, each of the front doors 14 and 16 of the protective cover assembly 20 of the transport refrigeration unit of the invention are of a composite construction having an inner sheet 50 and an outer sheet 60 which are bonded together at their respective peripheral edges 52, 62 to form a shell 70 about a core member 55 of preformed foam material sandwiched therebetween. An exemplary process for fabricating doors of such a composite construction is illustrated in FIG. 3. The doors 14 and 16 may be formed by a fabrication process wherein each of the inner sheet 50 and the outer sheet 60 are preformed from a desired plastic material, such as for example ABS plastic, at steps 101 and 102 and the core member 55 is preformed from a desired foam material, such as for example polyurethane foam, prior to assembly, at step 103. Thereafter, at step 104, the inner sheet 50 and the outer sheet 60 are assembled with their respective peripheral edges 52, 62 in contact and the foam core member 55 sandwiched between the inner plastic sheet 50 and the outer plastic sheet 60. With the inner plastic sheet 50, the outer plastic sheet 60 and the foam core member so assembled, the respective peripheral edges 52, 62 of the inner and outer plastic sheets are bonded together at step 105 to form an enclosed plastic shell 70 about the foam core member 55.

The step of bonding the respective peripheral edges 52, 62 of the inner and outer plastic sheets 50, 60 together may advantageously be carried out via a conventional thermoforming process wherein the assembly of the inner sheet, the outer sheet and the foam core member is heated in a thermoforming mold along the respective peripheral edges 52, 62 of the inner and outer sheets to a temperature sufficient to fuse the respective peripheral edges 52, 62 of the inner and outer sheets together. In using a thermoforming process to fuse the respective peripheral edges of the inner and outer plastic sheets together, sufficient heat will be imparted to the remainder of the inner and outer plastic sheets to thermally bonded the respective inside surfaces 53, 63 of the inner and outer plastic sheets 50, 60 to the surface of the foam core member 55 along its interface with the respective inside surfaces of the inner and outer sheets. In this manner, the absence of voids at the interface of the foam core member 55 and the respective inside surfaces 53, 63 of the inner and outer plastic sheets is assured.

In the method of the invention, the foam core member 55 is preformed prior to assembly, rather than being foamed in place within a preformed plastic shell as in conventional practice. Thus, foam materials other than those foams best suited for foam-in-place fabrication may be used. Consequently, the method of fabrication in accord with the invention provides the ability to selectively vary the properties of the foam material used to form the core member 55 to thereby selectively impart a particular desired characteristic to the foam core member. For example, the preformed foam core member 55 may be fabricated to have a desired density or degree of reticulation so as to impart a particular level of thermal insulating characteristic or sound dampening characteristic to the preformed foam core member 55.

While the present invention has been particularly shown and described with reference to the exemplary embodiments as illustrated in the drawing, it will be understood by one skilled in the art that various changes in detail may be effected therein without departing from the spirit and scope of the invention as defined by the claims.

We claim:

1. A method of fabricating a door for a cover of a transport refrigeration unit comprising the steps of:
forming a first sheet of a plastic material having a peripheral edge and a second sheet of a plastic material having a peripheral edge;
forming a core member of a foam material;
assembling said core member of foam material between said first sheet of plastic material and said second sheet of plastic material with the respective peripheral edges of said first sheet of plastic material and said second sheet of plastic material in contact; and
bonding the peripheral edges of first sheet of plastic material and said second sheet of plastic material together.

2. A method of fabricating a door for a cover of a transport refrigeration unit as recited in claim 1 wherein the step of bonding the respective peripheral edges of first sheet of plastic material and said second sheet of plastic material together comprises fusing the respective peripheral edges of first sheet of plastic material and said second sheet of plastic material together via a thermoforming process.

3. A method of fabricating a door for a cover of a transport refrigeration unit as recited in claim 2 further comprising the step of thermal bonding said preformed core member of foam material to said first sheet of plastic material and said second sheet of plastic material during said thermoforming process.

4. A method of fabricating a door for a cover of a transport refrigeration unit as recited in claim 1 further comprising the step of selectively varying at least one property of the foam material from which said core member is fabricated to selectively impart a desired characteristic to said core member.

5. A method of fabricating a door for a cover of a transport refrigeration unit as recited in claim 4 wherein the step of selectively varying at least one property of the foam material from which said core member is fabricated to selectively impart a desired characteristic to said core member comprises varying at least one of the density or the degree of reticulation of the foam material to selectively impart at least one of a desired thermal insulating value or a desired degree of sound dampening to said core member.

6. A method of fabricating a door for a cover of a transport refrigeration unit as recited in claim 1 wherein the step of forming a core member of foam material comprises forming a core member of a polyurethane foam material.

7. A method of fabricating a door for a cover of a transport refrigeration unit as recited in claim 1 wherein the step of forming a core member of foam material comprises forming a core member of a thermal insulating foam material.

8. A method of fabricating a door for a cover of a transport refrigeration unit as recited in claim 1 wherein the step of forming a core member of foam material comprises forming a core member of a sound dampening foam material.

9. A method of fabricating a door for a cover of a transport refrigeration unit as recited in claim 1 wherein the step of forming a core member of foam material comprises forming a core member of a reticulated foam material.

10. A transport refrigeration unit of the type adapted to be mounted on the front wall of a trailer for conditioning the environment interior of the trailer, the unit having a front cover for enclosing the refrigeration unit and including at least one front door, characterized in that the front door comprises:
a preformed core of foam material;
an inner sheet and an outer sheet of plastic material, said inner and outer sheets having respective peripheral edges which are bonded together to form a shell about said core of preformed foam material between said first and second sheets.

11. A transport refrigeration unit as recited in claim 10 wherein the respective peripheral edges of said first and second sheets are bonded together by a thermoforming process.

12. A transport refrigeration unit as recited in claim 10 wherein said preformed core of foam material comprises polyurethane foam.

13. A transport refrigeration unit as recited in claim 10 wherein said preformed core of foam material comprises a sound dampening foam.

14. A transport refrigeration unit as recited in claim 10 wherein said preformed core of foam material comprises a thermal insulating foam.

15. A transport refrigeration unit as recited in claim 10 wherein said first and second sheets of plastic material comprise an acrylonitrile butadiene styrene (ABS) plastic.

16. A transport refrigeration unit as recited in claim 10 wherein said preformed core of foam material comprises polyurethane foam.

17. A transport refrigeration unit as recited in claim 16 wherein said preformed core of foam material comprises a reticulated polyurethane foam.
